(19) United States
(12) Patent Application Publication
(10) Pub. No.: US 2008/0229154 A1
(43) Pub. Date: Sep. 18, 2008

(54) Self-referencing redundancy scheme for a content addressable memory

(76) Inventors: James I. Esteves, El Dorado Hills, CA (US); Richard E. Fackenthal, Carmichael, CA (US)

Correspondence Address: TROP PRUNER & HU, PC, 1616 S. VOSS ROAD, SUITE 750, HOUSTON, TX, 77057-2631, US

(21) Appl. No.: 11/717,237

(22) Filed: Mar. 13, 2007

(51) Int. Cl. G06F 11/16

(52) U.S. Cl. 714/42; 365/200; 711/108

(57) ABSTRACT

A self-referencing redundancy scheme in a content addressable memory may use a faulty bit table, populated during manufacturing, to indicate, not only the address of all the defective memory locations, but also the data which they should hold. Then, during read out, a read out state machine may access the faulty bit table, determine the data the faulty location should have held, and write that faulty data onto latches associated with the faulty memory elements.

### BACKGROUND

This relates generally to content addressable memory.

Content addressable memory is also called associative memory. It is memory which can be addressed using at least a portion of the content of the address.

Conventional memories generally have redundancy schemes. These redundancy schemes generally require defect detection. A degree of complexity arises from the need for defect detection. This complexity may encourage the omission of redundancy schemes from content addressable memories.

However, absent any redundancy, even a single manufacturing fault in a complex memory may result in the product being unusable. Thus, even a very small fault rate may result in the destruction of a substantial percentage of the manufactured parts.

### BRIEF DESCRIPTION OF THE DRAWINGS

FIG. 1 is a schematic depiction of a content addressable memory in accordance with one embodiment of the present invention;

FIG. 2 is a depiction of a memory element in accordance with one embodiment of the present invention;

FIG. 3 is a flow chart for a sequence for providing the correct data output when a faulty memory location is accessed, in accordance with one embodiment of the present invention; and

FIG. 4 is a system depiction in accordance with one embodiment of the present invention.

### DETAILED DESCRIPTION

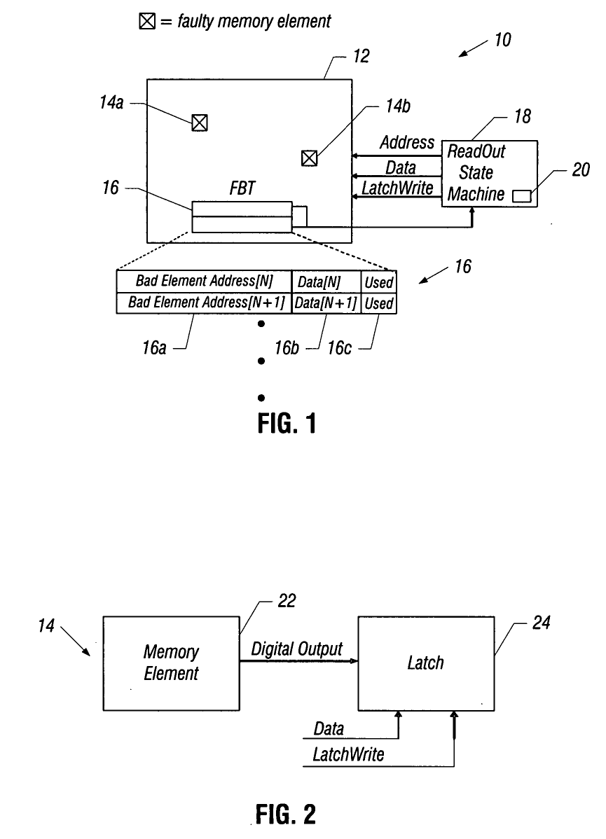

Referring to FIG. 1, a content addressable memory 10 may include a memory array 12 coupled to a read out state machine 18. The read out state machine 18 is responsible for reading out the data in the array 12 and may also implement sequences for replacing defective memory locations so that when a memory is manufactured that has defective locations, it need not be discarded. The read out state machine is coupled by address, data, and latch/write lines to the memory array 12.

The memory array 12 may be a content addressable memory, associative memory, or any memory which is accessed using part of the contents stored within the memory. Content addressable memory, for example, may be implemented using polysilicon fuses as cells. Generally, the memory 10 is programmed only one time, during manufacturing.

As manufactured, the memory array 12 may include one or more defective memory elements, such as the elements 14a and 14b, arranged at random locations within the array 12. In one embodiment, a faulty bit table 16 may be maintained in a predetermined array 12 location which is not utilized for normal memory operations. The faulty bit table 16 may include an entry for each defective location, including a field 16a for its address within the array, a field 16b for the data that should have been stored, and a field 16c for a bit to indicate whether the table entry is actually being used.

Referring to FIG. 2, each memory location in the array 12 may include a content addressable memory element 22 and an output latch 24. Thus, data is generally output upon selection from the memory element 14 to the latch 24 for read out. However, in some embodiments of the present invention, a latch 24 may include both data and latch/write inputs.

The latch/write and the data inputs may be coupled to the read out state machine 18, as indicated in FIG. 1. With this configuration, the read out state machine 18 may feed the data to the latch 24 rather than, as is conventional, merely reading out the data from the latch 24. The read out state machine 18 may do this in the situation where the memory location to be accessed is defective.

Thus, in some embodiments, during manufacturing and prior to release of the memory to a customer, the memory 10 may be tested and the defective locations may be identified. The addresses of those defective locations, and the data they should hold may be stored within the faulty bit table 16. Then, whenever the memory 10 is read out, the correct data may be provided by the read out state machine 18 which simply inserts the correct data (now stored in the table 10) onto the output latch 24 so that all of the memory 10 data is available for output in conventional fashion.

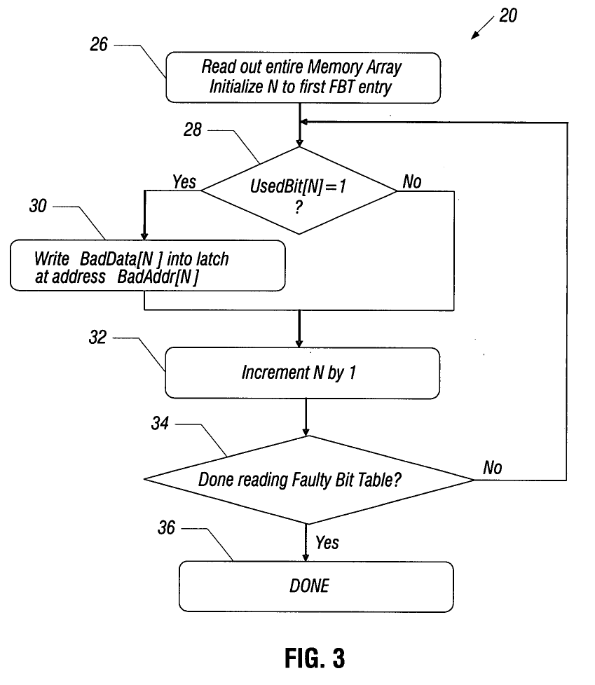

Referring to FIG. 3, the sequence 20 may be implemented by software, hardware, or firmware. In one embodiment, it may be stored within an appropriate computer readable medium such as a memory location within or coupled to the read out state machine 18. Initially, as indicated at 26, the sequence involves reading out the entire memory array 12. A variable N is initialized to the first faulty bit table entry. In one embodiment, the faulty bit table entries may be numbered, starting from N, in increments of one.

Thus, when a memory read out occurs, the entire memory array be read out. This means that all the data in all the memory elements that are not defective are read out and transferred to their latches 24.

A check at diamond 24 determines whether there are any defective memory element entries in the faulty bit table 16. If so, the data, from the table 16, associated with that element is written into the latch 24 at the address provided by the faulty bit table. Thus, the first entry in the faulty bit table is read first since the variable N was initialized at 26. Then at block 30, when the selected entry is utilized, the data for the detective memory element 22 is written into its latch 24 by the read out state machine 18.

A diamond 28 check determines whether the selected faulty bit table entry is actually being used. In one embodiment, if the field 16c (FIG. 2) is populated with a one, then the entry is utilized and, otherwise, (if populated with a zero) it is not utilized. It is, of course, assumed that the latch is still effective, even though the memory element 14 is defective.

Then, the variable N is incremented by one, as indicated in block 32. A check at diamond 34 determines whether all the entries in the faulty bit table have been read. If so, the flow ends and, otherwise, the flow iterates to read each of the entries in the faulty bit table 16.

After reading all the entries in the faulty bit table 16, the data from the content addressable memory 10 may be read out from all the latches 24, which will be populated either by the memory elements 22 or, in the case of defective memory elements 22, such as the defective memory elements 14a and 14b, by writing the data using the read out state machine 18 from the faulty bit table 16 to the latch 24.

The redundancy scheme may be considered to be self-referencing because the memory stores the faulty bit table that the memory “self-references” to self-correct itself during initialization. In some embodiments, circuitry for error detection may be unnecessary.

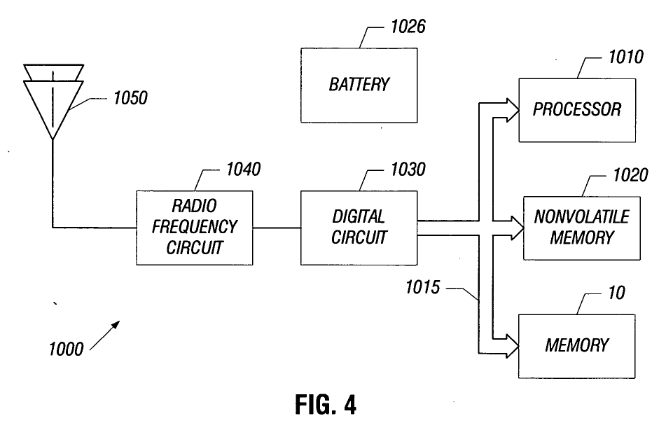

FIG. 4 shows an electronic system in accordance with various embodiments of the present invention. Electronic system 1000 includes processor 1010, non-volatile memory 1020, memory 10, battery 1026, digital circuit 1030, radio frequency (RF) circuit 1040, and antennas 1050. Processor 1010 may be any type of processor adapted to access non-volatile memory 1020 and memory 1025. For example, processor 1010 may be a microprocessor, a digital signal processor, a microcontroller, or the like.

Example systems represented by FIG. 4 include cellular phones, personal digital assistant, wireless local area network interfaces, or any other suitable system. Non-volatile memory 1020 may be adapted to hold information for system 1000. For example, non-volatile memory 1020 may hold device configuration data, such as contact information with phone numbers, or settings for digital circuit 1030 or RF circuit 1040. Further, non-volatile memory 1020 may hold multimedia files such as photographs or music files. Still further, non-volatile memory 1020 may hold program code to be executed by processor 1010. Non-volatile memory 1020 may be any of the memory embodiments described herein, including memory device 10 (FIG. 1). Many other systems uses for non-volatile memory 1020 exist. For example, non-volatile memory 1020 may be used in a desktop computer, a network bridge or router, or any other system without an antenna.

Radio frequency circuit 1040 communicates with antennas 1050 and digital circuit 1030. In some embodiments, RF circuit 1040 includes a physical interface (PHY) corresponding to a communications protocol. For example, RF circuit 1040 may include modulators, demodulators, mixers, frequency synthesizers, low noise amplifiers, power amplifiers, and the like. In some embodiments, RF circuit 1040 may include a heterodyne receiver and, in other embodiments, RF circuit 1040 may include a direct conversion receiver. In some embodiments, RF circuit 1040 may include multiple receivers. For example, in embodiments with multiple antennas 1050, each antenna may be coupled to a corresponding receiver. In operation, RF circuit 1040 receives communications signals from antennas 1050, and provides signals to digital circuit 1030. Further, digital circuit 1030 may provide signals to RF circuit 1040, which operates on the signals and then transmits them to antennas 1050.

Digital circuit 1030 is coupled to communicate with processor 1010 and RF circuit 1040. In some embodiments, digital circuit 1030 includes circuitry to perform error detection/correction, interleaving, coding/decoding, or the like. Also, in some embodiments, digital circuit 1030 may implement all or a portion of a media access control (MAC) layer of a communications protocol. In some embodiments, a MAC layer implementation may be distributed between processor 1010 and digital circuit 1030.

Radio frequency circuit 1040 may be adapted to receive and demodulate signals of various formats and at various frequencies. For example, RF circuit 1040 may be adapted to receive time domain multiple access (TDMA) signals, code domain multiple access (CDMA) signals, global system for mobile communications (GSM) signals, orthogonal frequency division multiplexing (OFDM) signals, multiple-input-multiple-output (MIMO) signals, spatial-division multiple access (SDMA) signals, or any other type of communications signals. The present invention is not limited in this regard.

Antennas 1050 may include one or more antennas. For example, antennas 1050 may include a single directional antenna or an omni-directional antenna. As used herein, the term omni-directional antenna refers to any antenna having a substantially uniform pattern in at least one plane. For example, in some embodiments, antennas 1050 may include a single omni-directional antenna such as a dipole antenna or a quarter wave antenna. Also, for example, in some embodiments, antennas 1050 may include a single directional antenna such as a parabolic dish antenna or a Yagi antenna. In still further embodiments, antennas 1050 may include multiple physical antennas. For example, in some embodiments, multiple antennas are utilized to support multiple-input-multiple-output (MIMO) processing or spatial-divisional multiple access (SDMA) processing.

Memory 10 represents an article that includes a machine readable medium. For example, memory 10 represents a random access memory (RAM), dynamic random access memory (DRAM), static random access memory (SRAM), read only memory (ROM), flash memory, or any other type of article that includes a medium readable by processor 1010. Memory 10 may store instructions for performing the execution of the various method embodiments of the present invention.

In operation, processor 1010 reads instructions and data from either or both of non-volatile memory 1020 and memory 1025 and performs actions in response thereto. For example, processor 1010 may access instructions from memory 1025 and program threshold voltages within reference voltage generators and reference current generators inside non-volatile memory 1020. In some embodiments, non-volatile memory 1020 and memory 10 are combined into a single memory device. For example, non-volatile memory 1020 and memory 10 may both be included in a single non-volatile memory device.

Although the various elements of system 1000 are shown separate in FIG. 3, embodiments exist that combine the circuitry of processor 1010, non-volatile memory 1020, memory 1025, and digital circuit 1030 in a single integrated circuit. For example, memory 10 or non-volatile memory 1020 may be an internal memory within processor 1010 or may be a microprogram control store within processor 1010. In some embodiments, the various elements of system 1000 may be separately packaged and mounted on a common circuit board. In other embodiments, the various elements are separate integrated circuit dice packaged together, such as in a multi-chip module, and, in still further embodiments, various elements are on the same integrated circuit die.

The type of interconnection between processor 1010 and non-volatile memory 1020 is not a limitation of the present invention. For example, bus 1015 may be a serial interface, a test interface, a parallel interface, or any other type of interface capable of transferring command and status information between processor 1010, non-volatile memory 1020, and memory 1025.

Step voltage generators, voltage references, flash cells, and other embodiments of the present invention can be implemented in many ways. In some embodiments, they are implemented in integrated circuits. In some embodiments, design descriptions of the various embodiments of the present invention are included in libraries that enable designers to include them in custom or semi-custom designs. For example, any of the disclosed embodiments can be implemented in a synthesizable hardware design language, such as VHDL or Verilog, and distributed to designers for inclusion in standard cell designs, gate arrays, or the like. Likewise, any embodiment of the present invention can also be represented as a hard macro targeted to a specific manufacturing process. For example, memory array (FIG. 1) can be represented as polygons assigned to layers of an integrated circuit.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
identifying, during manufacturing, a defective memory location in a content addressable memory;
storing, in the memory, the address of the defective memory location and the data that was to be stored in that location; and
programming said memory to transfer the data to a latch associated with said location for data read out.

2. The method of claim 1 including providing a table in said memory which lists the address of the defective memory location.

3. The method of claim 2 including providing a sequence of entries in the table for each of a plurality of defective memory locations in said memory.

4. The method of claim 3 including providing for each defective location the address of the defective memory location and the data that the defective memory location should have stored.

5. The method of claim 4 including providing an entry in said table to indicate whether the entry is actually being used or not.

6. The method of claim 5 including transferring the data from the table to a latch coupled to a defective memory element.

7. The method of claim 1 including storing a plurality of defective memory locations in a table, reading the addresses of said locations in said table, and writing data from said table to latches associated with defective memory locations for read out.

8. The method of claim 6 including successively reading a plurality of entries in said table to locate the data that should have been stored in defective memory locations.

9. The method of claim 8 including continuing to read entries in said table until the last entry has been read.

10. The method of claim 9 including providing an indicator in each entry in said table to indicate whether a given entry is utilized.

11. A content addressable memory comprising:
a memory array including a plurality of memory locations, said memory locations including a memory element and a latch, said latch coupled to said element; and
a table stored in said array to indicate locations which are defective.

12. The memory of claim 11 including a control coupled to a plurality of latches, each of said latches coupled to a memory element in said memory array.

13. The memory of claim 12 wherein said table stores an address of a defective memory location and the data that was to be stored in said memory location.

14. The memory of claim 13 wherein said table also includes a field to indicate whether or not the entry is actually utilized.

15. The memory of claim 11, said control to transfer data from an entry in said table to a latch associated with a defective memory element.

16. A computer readable medium storing instructions that, upon execution, enable a control to:
store, in a content addressable memory, the address of a defective memory location in said memory and the data that was to be stored in said location; and
transfer data to a latch associated with said defective memory location for data read out.

17. The medium of claim 16 further storing instructions to establish a table in said memory that lists the addresses of defective memory locations.

18. The medium of claim 17 further storing instructions to provide a sequence of entries in said table for each of a plurality of defective memory locations in said memory.

19. The medium of claim 18 further storing instructions to provide for each defective location the address of the defective memory location and the data that the defective memory location should have stored.

20. The medium of claim 19 further storing instructions to provide an entry in said table to indicate whether the entry is actually being used or not.

21. The medium of claim 20 further storing instructions to transfer the data from the table to the latch coupled to a defective memory element for read out.

22. The medium of claim 16 further storing instructions to store a plurality of defective memory locations in a table, read the addresses of said locations in said table, and write data from said table to latches associated with defective memory locations for read out.

23. The medium of claim 21 further storing instructions to successively read a plurality of entries in said table to locate the data that should have been stored in defective memory locations.

24. The medium of claim 23 further storing instructions to continue to read entries in said table until the last entry has been read.

25. The medium of claim 24 further storing instructions to provide an indicator in each entry in said table to indicate whether a given entry is utilized.

26. A system comprising:
a processor;
a wireless interface coupled to said processor; and
a content addressable memory comprising a memory array including a plurality of memory locations, said locations including a memory element and a latch, said latch coupled to said element and a table stored in said array to indicate locations that are defective, and further including a control to transfer data from said table to said latches for a read out for memory locations with defective memory elements.

27. The system of claim 26 including a control coupled to a plurality of latches, each of said latches coupled to a memory element in said memory array.

28. The system of claim 27 wherein said table stores an address of a defective memory location and the data that was to be stored in said memory location.

29. The system of claim 28 wherein said table also includes a field to indicate whether or not the entry is actually utilized.

30. The system of claim 26, said control to transfer data from an entry in said table to a latch associated with a defective memory element.
